(19) United States
(12) Patent Application Publication
(10) Pub. No.: US 2024/0248980 A1
(43) Pub. Date: Jul. 25, 2024

(54) ULTRASAFE LOGIN

(71) Applicant: Gaurav Sharma, New Delhi (IN)

(72) Inventor: Gaurav Sharma, New Delhi (IN)

(21) Appl. No.: 18/602,612

(22) Filed: Mar. 12, 2024

Related U.S. Application Data
(63) Continuation-in-part of application No. 17/657,490, filed on Mar. 31, 2022, now Pat. No. 11,928,202.
Application No. 17/657,490 is a continuation of application No. 16/612,736, filed on Nov. 11, 2019, now Pat. No. 11,514,152.

(30) Foreign Application Priority Data
May 11, 2017 (IN) 201711016640

(51) Int. Cl. G06F 21/45; G06F 21/36; H04L 9/32; H04L 9/40

(52) U.S. Cl. CPC G06F 21/45; G06F 21/36; H04L 9/3226; H04L 63/083

(57) ABSTRACT

Our Names in physical and real world have transformed into ‘username’s in virtual digital world. Anything that we need to access in digital world asks us for a ‘username’, which can be user selected (like an e-mail address) or provided to a user (like an employee ID/Number). This ‘username’ has indeed become a SuperName, giving access to restricted areas, based on privileges, links to other services as well. So, to a cybercriminal, if a ‘username; is known, more than half the job is done. And once corresponding password is cracked, the whole digital identity lies threadbare. Damages done through transactions of such unauthorized access may get quantified, but dent to privacy is far more damaging.

### CROSS-REFERENCE TO RELATED APPLICATION

This application is a continuation-in-part of U.S. patent application Ser. No. 17/657,490 filed Mar. 31, 2022, entitled “ULTRASAFE LOGIN”, which is incorporated by reference herein in its entirety, which is a continuation of U.S. patent application Ser. No. 16/612,736 filed Nov. 11, 2019, entitled “ULTRASAFE LOGIN” which issued as U.S. Pat. No. 11,514,152, which is incorporated by reference herein in its entirety, which claims priority to Patent Cooperation Treaty Application Number PCT/IB2018/053286, filed May 11, 2018, which is incorporated by reference herein in its entirety, which claims priority to Indian Application No. 201711016640 filed May 11, 2017, entitled “ULTRASAFE LOGIN” which is incorporated by reference herein in its entirety.

### BACKGROUND

UltraSafe endeavors to highlight this glaring gap and has devised innovative functional and technical methods to plug this gap. Sole objective of UltraSafe is to begin security from the very first step, i.e. the login screen by modifying the ‘username’ in innovative ways that become impossible for a bystander to see and understand or to significantly increase the difficulty level for guessing it correct.

UltraSafe stealth attribute is need based and can be accessed or removed depending on user preference, especially in public places. Let's view it as a large gathering of people for any purpose, may be working together a well, but not shouting or publicizing names (their names), but only when needed.

### Field of Invention

UltraSafe is an inventive step in field of Cyber Security wherein the ‘username’ is accorded stealth or similar protection while being entered in the ‘username’ field of a login screen.

UltraSafe is an inventive step in field of Cyber Security wherein even the ‘password’ is accorded stealth or protection similar to the Username field as described in detail, without any compromise on functionality or deterioration of desired services or results.

It is well known that basic and primary method of restricting access to a system is through a set of ‘username’ and password, wherein a password may be common for multiple users, but the ‘username’ is designed to be unique. Uniqueness of ‘username’ is diligently checked prior to even allocation, clearly highlighting importance of its purpose

UltraSafe transforms the entry of ‘username’ field in innovative ways to make it impossible for any bystander to read or decipher. Drawing from the perfect analogy of ‘Lock and Key’, the inventive step in UltraSafe is to hide the lock itself in a way that an attacker sees place for a lock but never be able to identify any of its aspects.

UltraSafe and all of its variants do not compromise on user convenience and user is able to switch off the stealth/scramble feature or see the real values being entered.

### Background of Invention With Regard to Drawkbacks Associated With Known Art

A set of lock and key symbolizes basic, visible security. In digital world, a ‘set’ of ‘username’ (u/n) and password (pwd) deliver similar result. Akin to a key, passwords are designed to be kept secret and akin to a lock, ‘username’ continues to lie in the open—currently.

In real and physical world, thieves and burglars target the lock first—not the Key. They will work to break the lock altogether or generate a key that opens the lock. Even in virtual and digital world, a cyber thief would target a known ‘username’ and then work to generate its corresponding key to enter the ‘username’-‘password’ restricted area.

On one hand, the lock or ‘username’ gives a feeling of secure access, on the other hand it raises curiosity, intrigue and fascination on what is being protected, prompting a possible attempt to break-in.

This holds true even for those who, with no intention or purpose of a theft/intrusion, wish to declare an achievement, show an expertise or expose a vulnerability.

Even with security paraphernalia like fencing or manually guarding a premise, thieves strike. Similarly, even with additional security paraphernalia like firewalls, SSL, encryption, etc., cyberthieves strike and gain entry through compromised ‘username's-password.’

To further add to misery, a convenience feature—AutoFill, allows previously filled data to be not just retained, but is clearly visible at the clock of mouse button or as and when you start entering anything in requisite place.

Even by using the popular virtual keyboard that shuffles alphabets randomly, there isn't an increase in security levels. One may be able to secure (to some extent), keypresses from data intercepting spyware, but is of no use against prying eyes. Shoulder surfing/surveillance is often the first step of cybercriminals against a potential victim. Target is not the person per se, but the ‘username’.

Ironically, in digital world, even cutting-edge technologies for security measures like firewalls, SSLs, DSCs, Tokens etc. have a human being as a user/administrator. And, to configure any of these measures, it all starts with a ‘username’.

So, the “Lock” is out in the open and for anyone to pick on—physical lock or ‘username’. Such digital footprints are fully ignored fearing user restrictions of inconvenience.

By ensuring that ‘username’ gets accorded seriousness and secretiveness of levels similar to passwords, a significant number of attacks or potential attacks can thus be reduced.

Yet, no amount of security (physical or digital) is ever enough. It is a continuous marathon tussle between defenders and attackers. Prudence demands to continuously provide/upgrade cybersecurity measures and always be a leap ahead of attackers-before they catch up again. The loser obviously loses a lot more than just valuables.

### OBJECT OF INVENTION

The object of UltraSafe Login invention is the humble ‘username’ which is always visible to anyone and everyone and becomes a starting point for hacking, but security around the same is completely ignored. A simple account when hacked, opens possibilities of serious damage at a later stage. Hence, to increase security, accounts being used need to be secured further and UltraSafe aims to exactly achieve it through innovative methods without compromising on user convenience.

Forensics often point out that accounts get compromised due to passwords(s) becoming known (by any means), actually, it is a ‘set’ of ‘username’ and password and not just passwords. Security aspects are continuously focused on passwords, which are mere keys to the lock. Endeavor is thus to equally secure the ‘username’, rather than just password.

UltraSafe Login is also particularly useful for Remote Administration Consoles, wherein a user logs in to the console of a remote machine, accesses a restricted area/application secured by a ‘username’ and ‘password’, but is completely oblivious of any watchful eyes.

Object of UltraSafe Login invention is also to accord similar level of security (as being discussed in detail for the username field) for the ‘password’ field as well, bringing both at par and exponentially increasing the difficulty levels for hackers/crackers/attackers.

### STATEMENT OF INVENTION

UltraSafe Login is transforming the onscreen ‘username’ in a way making it impossible for a bystander to read or understand, thereby significantly decreasing possibilities of account hacking, at the same time not compromising on user convenience.

UltraSafe Login is also the transformation of the password field by bringing both username and password fields at par in terms of security defined for either.

### SUMMARY OF INVENTION

The inventive step allows users themselves, or service providers to choose one of the methods of letting their users, enter their ‘username’ in a manner that makes it meaningless to any bystander. At the same time, the said ‘username’ could be viewed in ‘normal’ mode as if the chosen security feature(s) weren't applied when the user hovers a mouse over the ‘username’ field or by clicking on the view button given alongside the UltraSafe ‘username’ field.

The said ‘username’ transformation may be based on one or more attributes like language, stealth, obscure, garble, rearrangement etc. and is easily reconverted into the mode understood by the user as shown in the examples in detailed description.

### BRIEF DESCRIPTION OF THE DRAWINGS

A typical login screen is shown in FIG. 1.

FIG. 2 depicts an UltraSafe Login Screen (Ultra.Safe is switched Off)

FIG. 3 depicts an UltraSafe Login Screen where ‘username’ when entered, can be easily, password is obfuscated (Utlra.Safe is switched Off).

FIG. 4 depicts an UltraSafe Login Screen with view buttons appear for both. ‘username and password’ (UltraSafe is switched On).

FIG. 5 depicts an UltraSafe Login Screen where ‘username appears obfuscated, when entered (Ultra.Safe is switched On)

FIG. 6 depicts an UltraSafe Login screen where an obfuscated username can be seen only by clicking on the View Button (Ultra.Safe Login is switched On)

FIG. 7 depicts an UltraSafe Login Screen where obfuscated password can be seen only by clicking on the View Button (Ultra.Safe is switched On)

FIG. 8 depicts an UltraSafe Login Screen where obfuscated ‘username’/password cannot be seen if not clicked on the view button (Ultra.Safe is switched On).

### DETAILED DESCRIPTION

It is well known that numerous IT applications (hereafter referred as ‘Application’ and referring to any technology-based interface, accessed on IT devices like computers, servers, mobile devices etc. or through a web browser for websites or as a local installation or a remote installation etc.) deploy numerous security safeguards to ensure authorized access.

The most common method is to allow access through a ‘Login’ Screen, wherein users enter a ‘username’ and a ‘password’. It is assumed that password would be kept secured/secret/safeguarded by the holder/provider/manager etc., of said ‘username’.

Such ‘username’ and ‘password’ are entered/typed/echoed on this ‘Login’ screen in text boxes or when prompted to enter a secured area/resume a locked out session/ad-hoc user validation check etc.

Both ‘username’ and password are required to get matched against corresponding entries as stored in database. Incorrectness in any or mismatch between the ‘username’ & ‘password’ as a singular set will result in a failed attempt login.

UltraSafe Login is a simple method wherein the ‘username’ field in a login screen reflects a modified onscreen output, based on the method chosen by the user and/or system configuration, post which it does not remain the readily readable ‘username’ entered by user.

UltraSafe Login also has an optional stealth mode, wherein the ‘username’ even if entered continues to be shown as blank/non-modifiable field/same color as the background to give an impression of no entries have been made.

In a few UltraSafe variants, the entries made by the user are displayed in a modified manner by using a cipher for each character entered by the user.

User can, if this option is so configured, optionally click on ‘view’ button, available next to UltraSafe ‘username’ field and view the entry made.

User can, if this option is so configured, optionally hover the mouse pointer over UltraSafe ‘username’ field and view the entry made.

If, user chooses to not click on the view button or do a mouse pointer hover over the UltraSafe ‘username’ field, but is confident that the ‘username’ entry made is correct, clicks on login or similar button to proceed, the UltraSafe based system so configured would treat the entry without prejudice and modification and return the result as ‘invalid username’ if it was entered incorrectly or allow access if it was indeed entered correctly. This is based on assumption and premise that the corresponding password so entered was also correct and was not the cause of error/denied access.

Though, enhancing security of the username is being professed in this invention, particularly comparing username field security to existing security available for the password field, UltraSafe Login's objective is to secure the overall login process and the same can be achieved best only if both username and password fields have optimal UltraSafe login security. However, this is not a limiting factor and parity in security level is optional.

Giving below one of the forms (obfuscation) of the UltraSafe Login for clearer understanding::

A typical login screen is shown in FIG. 1.

FIG. 1::A General Login Screen

In a general login screen, password is usually obfuscated while ‘username’ is not.

Numerous methods are known to ‘crack’ passwords. With advancements in technology and a desire to unhide the hidden, numerous software are available to ‘crack’ passwords. Such actions allow unauthorized access once the said password is ‘cracked’. Underlying problem with this method is that a password is mapped to the said ‘username’ and once password is ‘username’ is identified, ‘cracker’ or attacker enters the known set of ‘username’ and password in designated location and gains access.

All this happens since the ‘username’ is known.

By hiding/obfuscating the ‘username’ and well, UltraSafe makes the task of hackers/crackers almost impossible, since the hackers/crackers now do not even know what to lock to break.

To use an analogy of ‘username’ and ‘password’ as ‘Lock and Key’, ‘UltraSafe Login’ ensures that even the ‘Lock’ is also not known to anyone even if its ‘Key’ becomes known.

So, UltraSafe creates a conundrum for the hackers/crackers in terms of what to crack first and how . . . since the key cannot be created as the lock is not known and lock cannot be created even if key is known. So, effectively, the crackers do not know what to crack?

At the same time, ‘UltraSafe Login’ does not provide any inconvenience to the Users, since a bondafide or an authorized user would be aware of his/her ‘username’. Thus, in a public place or place of work, Users can choose to hide their ‘username’ also from prying eyes.

In case, the User does feel the need to see the entered ‘username’, existing technologies of showing/viewing the obfuscated data is applied to the ‘username’ field also, ensuring the User to view/correct the entered ‘username’.

Additionally, a convenient, simple to use ‘UltraSafe Login’ Toggle Switch is also provided that allows Users to switch off this voluntary feature. So, Users can switch off the ‘UltraSafe Login’ at home or in private areas where no once can see what is being entered.

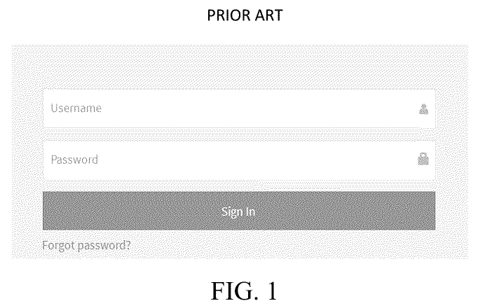

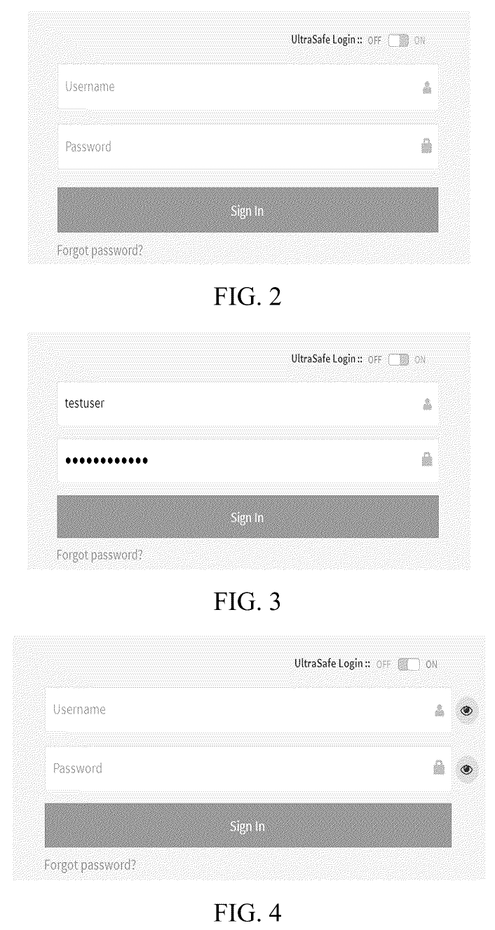

The following figures show the simple ‘UltraSafe Login’. FIG. 2 is an UltraSafe Login Screen (Ultra.Safe is switched Off)

FIG. 3 shows that ‘username’ when entered, can be seen easily, password is obfuscated Ultra.Safe is switched Off

In FIG. 4 View buttons appear for both ‘username and Password (Ultra.Safe is switched On)

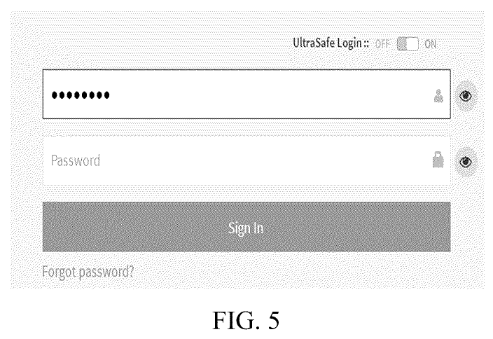

In FIG. 5 username appears obfuscated, when entered (Ultra.Safe is switched On).

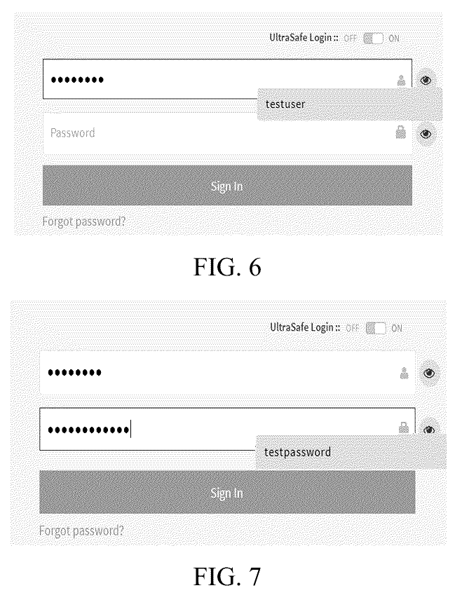

In FIG. 6 Obfuscated username can be seen only by clicking on the View Button (Ultra.Safe is switched On)

In FIG. 7 Obfuscated Password can be seen only by clicking on the View Button (Ultra.Safe is switched On)

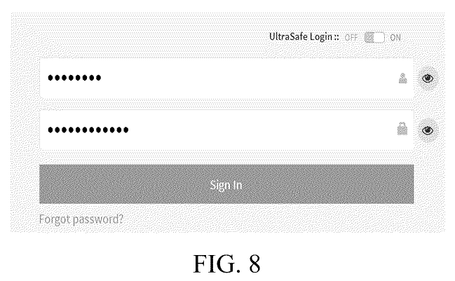

In FIG. 8 Obfuscated ‘username’/Password cannot be seen if not clicked on the view button.

(Ultra.Safe is switched On)

As can be clearly seen, the UltraSafe Login, without compromising on user convenience or desired functionality, not only completely secures the username, but also completely defines the privacy aspects as desired by every user.

An additional example of UltraSafe Login is using a smart cipher for Username and Password that could also be set by the users themselves.

To explain this simply, let's assume that every user has the following set of credentials for logging into a system::

Username::Gaurav

Password::Sharma

The configured cipher for this system converts this set as follows

Username::Ultra

Password::Safe

So, now whenever the said user would enter the username as shown in [0061], the smart cipher will convert it into [0064] and similarly, when the password is entered as shown in [0054], the smart cipher displays the text as [0065]. It needs to be noted that simple English text has been used for explanation and UltraSafe Login is not limited to this alone and different ciphers could be deployed by users and system designers.

This would happen every time and each time, assuring the user that if such strings are displayed, the entries made are correct and the so configured system shall allow requested access.

However, to an attacker this would seem to be a walk in the park, but any such misdemeanor would never get executed.

In a further enhancement, the users should be allowed to choose their own ciphering mechanism once they have logged in to a system, with or without UltraSafe, in a way that they can easily memorize the ciphered details. In such a case, once the user enters the actual username and password and clicks out of the designated field area, if the username and passwords entered are correct, the ciphered string would be displayed. If the ciphered string is not displayed/is incorrect, the user can undertake required corrections. Thus, even before clicking on the login/proceed button, the users get to know if the details entered by them are correct or not.

The most interesting aspect for this example is that once an attacker attempts to log on to the restricted access area, the available security apparatus can easily track the same. Thus, not only undesired intrusion is prevented or trapped at that point of time, (e.g., necessary) flagging could be undertaken to mark such prospective threat for future.

UltraSafe Ciphered Output can also be applied to other critical details that a user sees or enters in an application or any such stored detail or to a mathematical output obtained by a formula(e). Such information could be profile details or financial details or any other detail (but not restricted to the following examples alone):

First Name;

Last Name;

Full Name;

Address;

E-Mail ID;

Communication Numbers (Landline/Mobile/Fax etc);

Date fields (Of Birth/Issuance/Expiry/Term etc);

Maiden Names;

Identity testing Questions or formula(e);

PINs (Personal Identification Numbers) used for ATMs or similar;

Account Numbers (ID/Registration/Loyalty/Charge/Debit/Credit Card (including CVV)/Bank/Loan/Insurance etc.); and/or

OTPs (One Time Password or Passphrase) or PINs used for online or offline transactions.

The ciphered/non-ciphered output of UltraSafe protected fields (including login details and/or profile detail and/or mathematical output (s) and/or combination of one or more such details, any or all of which may be stored previously or are being entered in real time) may further be stored electronically in a database in an encrypted manner through another algorithm and encryption. This ensures that such details are visible in a comprehensible manner, but still unusable, to even database or application administrators or such managers.

UltraSafe Reverse allows the users, who are aware of their UltraSafe ciphered output for their defined fields, to share the said output to another person who is then able to choose the said reversing cipher to decipher the encrypted details and only then view the said protected fields.

For example, today a service provider, be it a bank or a cellular company or gas company or electricity company or fuel company or anyone in a transactional relationship with the said user through their organization is able to simply input a customer id or account number or a similar identifier and is able to see all details, necessary or unnecessary, profile details or transactional history, etc, which is a clear breach of privacy and deemed necessary or unavoidable or consequential or.

Taking the same example of UltraSafe Ciphered Output shown earlier, UltraSafe Reverse allows user to share the ciphered output ‘Ultra’ (as earlier described) with the intended person, who then after choosing the available correct reversing cipher gets to see the output as ‘Gaurav’ (as earlier described).

This can further be utilized in manual entry of a unique ciphered output of a unique card number and other associated required details in a POS/Swipe/similar card reading machine instead of using the said magnetic stripe, since these outputs are known only to the said user.

This may additionally be secured by use of standard multi-factor authentication processes.

UltraSafe Total is a combination cipher and/or ciphered output of individual un-ciphered or ciphered outputs of a particular data string that may correspond to defined structured fields to allow further simplified usage of UltraSafe, for a one time usage or repeat usage as defined by the user.

For example, a card with all relevant information may get condensed into a single cipher, that may be consolidation of Card Number, Card Holder, Issuer, Date Of Expiry, CVV Number etc. Once this condensed cipher is entered, all relevant details are sent to the Card issuer who could further secure the transaction with Multi-Factor authentication processes such as OTPs.

Standalone usage of UltraSafe or in combination with other UltraSafe variants, all critical information could actually be stored in an encrypted form. UltraSafe Match is another variant of UltraSafe wherein the ciphered output of transactional details gets matched between entries done by the user with that of similar ciphered output stored during issuance or first storage or generation of such details, which may also be in real-time.

For example, online payment processes require the users to enter their Credit Card Number along with Name of the Card Holder, Date of Expiration and CVV Number (Not restricted alone to these information areas).

UltraSafe would provide a ciphered output (based on the applicable selected cipher) that is seen by the User, while the details are actually obfuscated. Once the user is satisfied that the entered details are indeed correct, s/he similarly provides other details.

These details too are obfuscated and UltraSafe protected, transmitted to the card issuer in an encrypted form, where it is further matched with the stored output (same as that of the actual pre-ciphered details and as seen on Card by the User). The transaction is allowed to pass through or blocked depending on the successful match of the said two entries.

All this while, the actual details never form part of any transport and are available securely with the User and Card Issuer.

This also allows manual entry of a card number and other required details in a POS/Swipe/similar card reading machine instead of using the said magnetic stripe which can be easily cloned in today's world.

This methodology is different from the standard practice of storing and matching passwords as at both ends ciphered output is being used rather than encryption of details being entered and matching with the encryption of stored values. Further, simply changing the UltraSafe cipher would result in different outputs at both ends.

UltraSafe is not just standard encryption-decryption, but a true end-to-end identity or details' security mechanism which involves users first, lets users remain the owners, lets users initiate and secures Receivers as well in case of UltraSafe Reverse, UltraSafe Match, UltraSafe Total (individually or a combination of one or more variants).

For example a Frequent Flyer seeking help from a helpdesk need not disclose/let the helpdesk know his/her details, rather focus on the help being sought as defined per process.

For example, a bank may simply send an OTP to its customer as and when any employee tries to access customer details, whether through the UltraSafe output (any variant) or otherwise, to stop any unauthorized access of Customer details by users who may be ex/internal to the bank.

For example, a mobile phone company helpdesk need not see customer details once the same are UltraSafe protected and provide required services as requested. Currently, the mobile phone company itself has no clue if they are indeed talking to the real user or someone masquerading as one by using a cloned SIM card.

I claim:

1. A computer-implemented method comprising:
receiving, by one or more processors, user details as input from a user, in respective fields on a graphical user interface (GUI) comprising an application or form filling screen of a computer application;
generating, by the one or more processors, a ciphered text corresponding to the received user details;
displaying, by the one or more processors, the ciphered text as a modified onscreen output on the login screen, alongside a respective entered user detail which is shown in an unreadable form on the login screen;
providing, by the one or more processors, viewing controls to the user, accessible via the GUI, wherein the viewing controls comprise a given control, where based on utilizing the given control, the unreadable form of the user details are made viewable on the application or form filling screen or are not viewable on the application/form filling screen; and
verifying, by the one or more processors, the user is an authorized user of the application based on the ciphered text displayed as the modified output on the login screen, whether or not the unreadable form of the entered user detail are viewable based on the user utilizing the given control.

2. The computer-implemented method of claim 1, wherein the user details are selected from any of First Name, Last Name, Full Name, Address, E-Mail ID, Communication Numbers, Date fields, Maiden Names, Identity testing Questions or formula, security PINs, bank account related details, OTPs (One Time Passwords) or PINs used for online or offline transactions.
